(19) United States
(12) Patent Application Publication
(10) Pub. No.: US 2011/0139905 A1
(43) Pub. Date: Jun. 16, 2011

(54) ROTARY SWITCHED SHOWER AND ITS METHOD OF SWITCHING

(75) Inventors: Wenxing CHEN, Xiamen (CN); Bin CHEN, Xiamen (CN); Renzhong LI, Xiamen (CN); Huasong ZHOU, Xiamen (CN)

(73) Assignees: Huasong ZHOU, Xiamen (CN); XIAMEN SOLEX HIGH-TECH INDUSTRIES CO., LTD., Xiamen (CN)

(21) Appl. No.: 12/637,130

(22) Filed: Dec. 14, 2009

(51) Int. Cl. B05B 1/14

(52) U.S. Cl. 239/562

(57) ABSTRACT

A rotary switched shower includes: a shell connected to a handle and a water outlet device. A turntable is fixed to the handle. The shell is fixed to front cover, and they form a chamber containing the water outlet device and a water inlet hole. The water outlet device and the front cover form at least two function water channels. An upper water segregator is fixed to the shell. At least two function water holes which are connected to a function water channel are contained in the upper water segregator. When the shell is turned a certain angle relative to the upper water segregator, the water inlet hole in the turntable is connected to a function water hole. A user can switch the function water channel by rotating the shell relative to the handle. The larger volume of the shell increases the contact area for the users hand.

### FIELD OF INVENTION

The present invention relates to a shower, and more specifically to a rotary switched shower which has multiple functions of water outlet and its method of switching.

### BACKGROUND OF THE INVENTION

The shower in existing technology has already not only had the function of sprinkling water, but also had multiple functions of water outlet to satisfy the demands of different people and different time, which has been used extensively. In order to exchange functions of water outlet, people often use the switch set up in the existing multifunction shower. In order to make it more convenient to switch water channels, sometimes a plectrum, which is used to turn the front cover to rotate, is set up on the front cover. But because of the smaller volume of the front cover, when user is holding it, the contact area is too small to hold it easily, which makes it difficult to turn the front cover to rotate. For example, the inventions published in the Chinese patent applications No. CN101041146A and No. CN201042681Y both have the above shortage.

### SUMMARY OF THE INVENTION

The main purpose of the present invention is to overcome the shortage of the inconvenience of switching different function water channels and the present invention supplies a rotary switched shower and its method of switching.

The present invention adopts the following technology programme:

A rotary switched shower includes a shell, a front cover, a handle, and a device of water outlet. The handle is connected with the shell and could rotate around it. The shell and the front cover are fixed to each other, and they form a chamber in which the device of water outlet is laid out. The device of water outlet and the front cover form at least two function water channels. In the chamber, a turntable fixed to the handle and an upper water segregator fixed to the shell are in contact with each other, and a water inlet hole is set up in the turntable. At least two function water holes set up in the upper water segregator, each of which is constantly connecting with a function water channel. When turn the shell a certain angle relative to the upper water segregator, the water inlet hole in the turntable is connected with a function water hole in order to make the relevant function water channel connected with the water inlet hole.

In one preferable embodiment of the present invention, the said device of water outlet includes a lower water segregator, an impeller, a commutator and a TPR cover, which together with the said front cover form a massage water channel, a spray water channel and a shower water channel. Correspondingly, the said water upper segregator has a massage water hole, a spray water hole and a shower water hole.

In one preferable embodiment of the present invention, additionally a blind hole for assembly is set up in the upper water segregator.

In one preferable embodiment of the present invention, the said lower water segregator and the said front cover fit together and form a shower water chamber, a massage water chamber and a spray water chamber which are arranged from outside to inside.

In one preferable embodiment of the present invention, the said impeller laid out in the massage water chamber rotates with water flow in the massage chamber, which consists of a horizontal arc plate and several vertical blades on the arc plate.

In one preferable embodiment of the present invention, the said shell covers and encloses the front cover.

In one preferable embodiment of the present invention, an assembly hole is set up at the top of the shell, and at the end of the said handle a head is added down-facing, which is inserted into the assembly hole and is fixed to the turntable with a screw.

A switching method of the rotary switched shower, comprises the following steps: (1) turn the shell to rotate relative to the handle, when the water inlet hole in the turntable fixed to the handle connects with the one of the function water holes, the relevant function water channel is connected. (2) continue to turn the shell to rotate relative to the handle, when the water inlet hole in the turntable fixed to the handle connects with another one of the function water holes, the relevant function water channel is connected.

From the above description of the present invention, we can see, compared with the existing technology, the rotary switched shower has the following advantage: the present invention makes the turntable fixed to the handle, the upper water segregator fixed to the shell, and user could turn the shell to rotate relative to the handle so as to switch the relevant function water channel. And because of the larger volume of shell, when user is holding it, the contact area is lager and the hand feel is nicer, which make it more convenient to switch.

### BRIEF DESCRIPTION OF THE DRAWINGS

FIG. 1 is a three-dimension exploded view in a preferable embodiment of the present invention.

FIG. 2 is a sectional view in a preferable embodiment of the present invention.

FIGS. 3 to 6 are schematic views in a preferable embodiment of the present invention.

FIG. 7 is a side view in a preferable embodiment of the present invention.

FIG. 8 is a schematic view of the turntable in a preferable embodiment of the present invention.

### DESCRIPTION OF SPECIFIC EMBODIMENTS

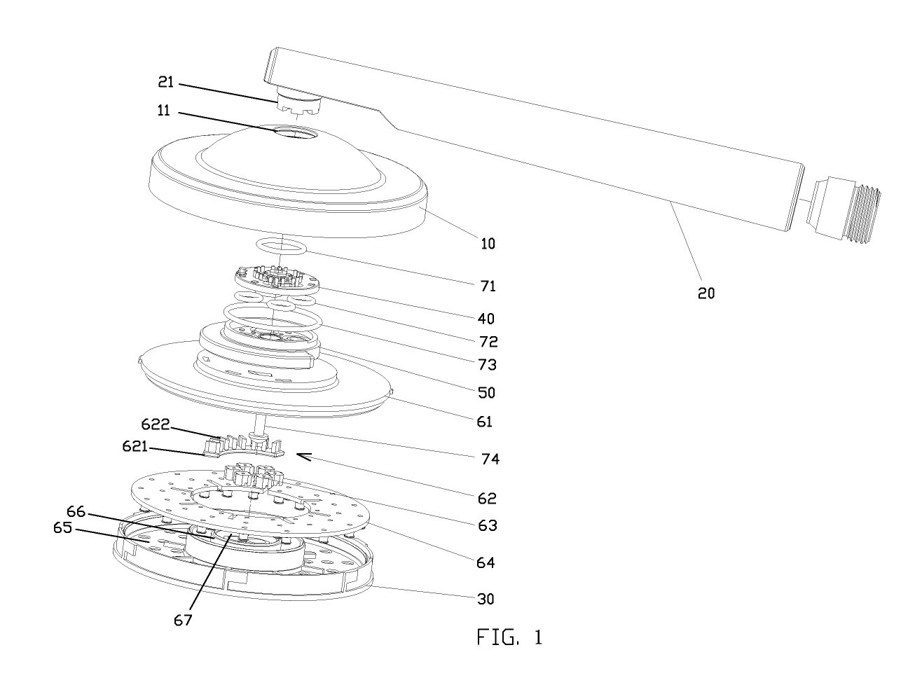

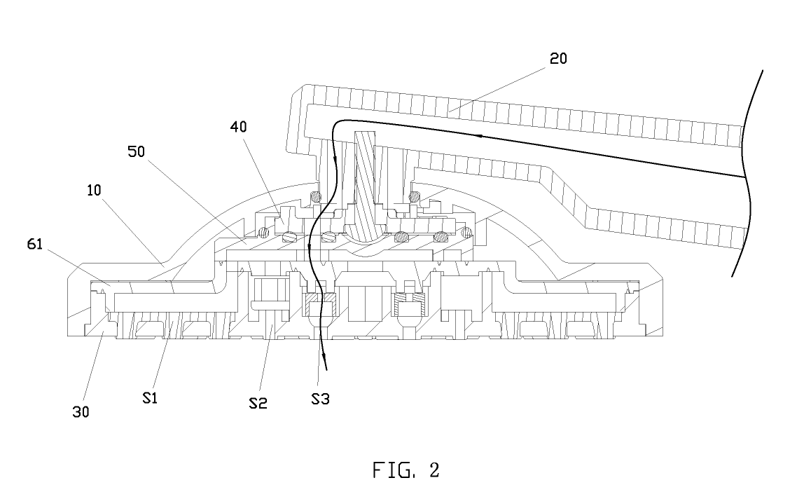

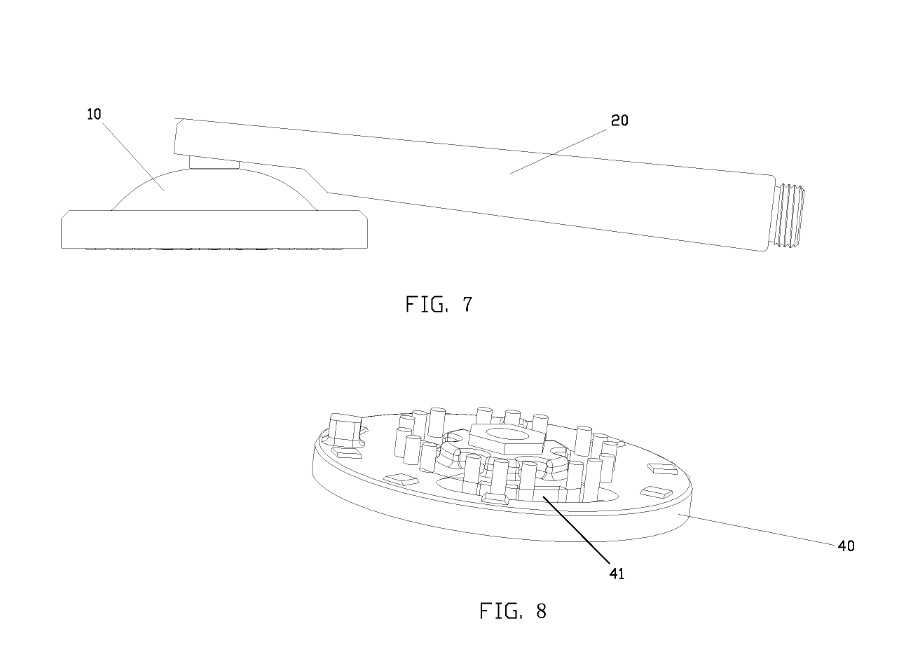

Referring to FIGS. 1 to 8, the present invention relates to a rotary switched shower including: a shell 10, a handle 20, a front cover 30, a upper water segregator 50 and a device of water outlet. An assembly hole 11 is set up at the top of the shell 10, and at the end of the handle 20, a head 21 is added down-facing, which is inserted into the assembly hole 11 of the shell 10 and is fixed to the turntable 40 with a screw 74. The shell 10 and the front cover 30 are fixed to each other and they form a chamber where the upper water segregator 50, the device of water outlet are fixed, so that the shell 10, the front cover 30, the upper water segregator 50 and the device of the water outlet compose a integrity which could rotate relative to the handle 20.

The turntable 40 is in contact with the upper water segregator 50 which connects with the device of water outlet; a water inlet hole 41 is set up in the turntable, and because of the turntable fixed to the head 21 of the handle 20, after flowing out of the head 21 of the handle 20 water only flows from the water inlet hole 41 of the turntable 40 to the upper water segregator 50. In the upper water segregator 50, a shower water hole 51, a massage water hole 52, a spray water hole 53 and a blind hole 54 are set up, and the blind hole 54 is used for alignment assembly of the present invention in production.

The device of water outlet includes a lower water segregator 61 under the upper water segregator 50, an impeller 62, a commutator 63 and a TPR cover 64. The lower water segregator 61 and the front cover 30 fit together and form a shower water chamber 65, a massage water chamber 66 and a spray water chamber 67 which are arranged from outside to inside. The TPR cover 64 is embedded in the front cover 30 in the shower water chamber 65, so shower water flows out of the shower water chamber 65. The impeller 62 set up in the massage water chamber 66 rotates with water flow, which consists of a horizontal arc plate 621 and several vertical blades 622 on the arc plate 621. In the massage water chamber 66, water flow impacts the impeller 62 to rotate so as to generate massage water. In the spray water chamber the commutator 63 is set up to generate spray water.

The upper water segregator 50, the lower water segregator 61, the impeller 62, the commutator 63, the TPR cover 64 and the front cover 30 together form a shower water channel S1, a massage water channel S2, a spray water channel S3.

In the present invention, the seal rings 71, 72, 73 are set up at junctions of all the parts to form a sealed internal environment where water flows.

In the present invention, because the turntable 40 is fixed to the handle 20 with a screw 74, the upper water segregator 50, the front cover 30, and the shell 10 are fixed together, and the turntable 40 and the upper water segregator 50 are contact with each other, when turn the shell 10 to rotate relative to the handle 20, the water inlet hole 41 in the turntable 40 is in turn connected with the shower water hole 51, the massage water hole 52 and the spray water hole 53 in the upper water segregator. As a result, the rotary switched shower of the present invention could generate shower water, massage water and spray water in turn.

In the present invention, because of the larger volume of the shell, when user is holding it, the contact area is larger and the hand feel is nicer, which makes it more convenient to switch.

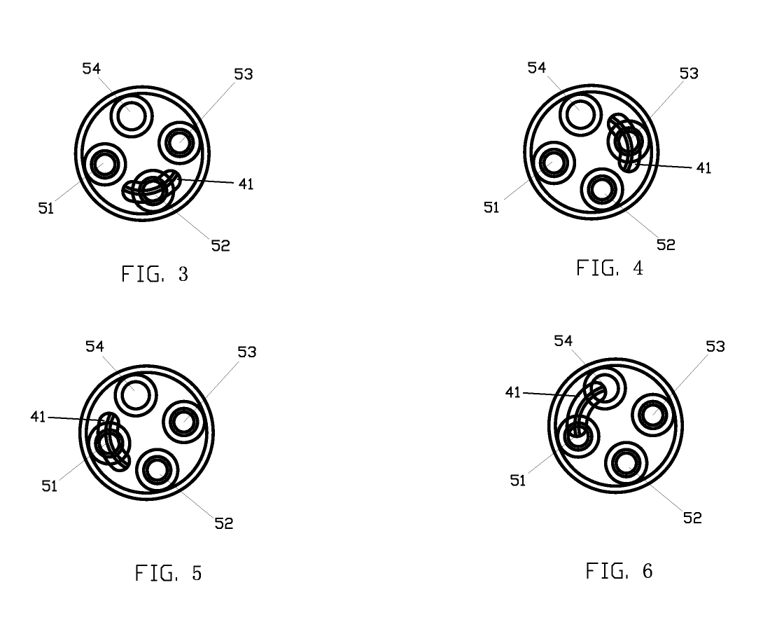

Referring to FIG. 3, when the shell 10 is rotating relative to the handle 20 to connect the water inlet hole 41 in the turntable 40 with the massage water hole 52 in the upper water segregator 50, the massage water channel is connected, and water flows from water inlet hole 41 and the massage water hole 52 to the massage water channel S2. As a result, the rotary switched shower of the present invention could generate massage water.

Referring to FIG. 4, when the shell 10 is rotating relative to the handle 20 to connect the water inlet hole 41 in the turntable 40 with the spray water hole 53 in the upper water segregator 50, the spray water channel is connected, and water flows from water inlet hole 41 and the spray water hole 53 to the spray water channel S3. As a result, the rotary switched shower of the present invention could generate spray water.

Referring to FIG. 5, when the shell 10 is rotating relative to the handle 20 to connect the water inlet hole 41 in the turntable 40 with the shower water hole 51 in the upper water segregator 50, the shower water channel is connected, and water flows from water inlet hole 41 and the shower water hole 51 to the shower water channel S1. As a result, the rotary switched shower of the present invention could generate shower water.

Referring to FIG. 5, when the shell 10 is rotating relative to the handle 20 to connect the water inlet hole 41 in the turntable 40 with a part of the shower water hole 51 in the upper water segregator 50, the end of the water inlet hole 41 is connected with the shower water hole 51 and the other end of the water inlet hole 41 is connected with the blind hole 54. So the shower hole S1 is connected, and water flows from the water inlet hole 41 and the shower water 51 to the shower water channel S1. As a result, the rotary switched shower of the present invention could generate water-saving shower water so as to achieve the function of saving water.

In addition, although in the embodiment, the upper water segregator, the device of water outlet and the front cover form together the shower water channel, the massage water channel and the spray water channel in order to make the rotary switched shower of the present invention could generate shower water, massage water and spray water. But actually, the importance of the claims in the present invention is not how many water channels are and what types of water channels are, but the rotation of the shell and the handle, and in this invention the way of switching water channels is to turn the shell to rotate relative to the handle by hand. Because of the larger volume of shell, when user is holding it, the contact area is lager and the hand feel is nicer, which make it more convenient to switch. Therefore all the showers having two types of water outlet are in the scope and spirit of this invention, no matter how many types of water channels are and no matter what types of water channels are.

In a word, all above is just one of the embodiments in the present invention, but the present invention is not limited in the embodiment. It should be understood that according to the design concept of the present invention, all the unessential modifications and alterations of the present invention will be apparent in the scope of claims of this invention.

What is claimed is:

1. A rotary switched shower includes a shell, a front cover, a handle, and a device of water outlet. The handle is connected with the shell and could rotate around it. The shell and the front cover are fixed to each other, and they form a chamber in which the device of water outlet is laid out. The device of water outlet and the front cover form at least two function water channels. In the chamber, a turntable fixed to the handle and an upper water segregator fixed to the shell are in contact with each other, and a water inlet hole is set up in the turntable. At least two function water holes set up in the upper water segregator, each of which is constantly connecting with a function water channel. When turn the shell a certain angle relative to the upper water segregator, the water inlet hole in the turntable is connected with a function water hole in the upper water segregator in order to make the relevant function water channel connected with the water inlet hole.

2. The rotary switched shower of claim 1, wherein the said device of water outlet includes a lower water segregator, an impeller, a commutator and a TPR cover, which together with the said front cover form a massage water channel, a spray water channel and a shower water channel. Correspondingly, the said water upper segregator has a massage water hole, a spray water hole and a shower water hole.

3. The rotary switched shower of claim 2, wherein a blind hole for assembly is additionally set up in the upper water segregator.

4. The rotary switched shower of claim 2, wherein the said lower water segregator and the said front cover fit together and form a shower water chamber, a massage water chamber and a spray water chamber which are arranged from outside to inside.

5. The rotary switched shower of claim 4, wherein the said impeller laid out in the massage water chamber rotates with water flow in the massage chamber, which consists of a horizontal arc plate and several vertical blades on the arc plate.

6. The rotary switched shower of claim 1, wherein the said shell covers and encloses the front cover.

7. The rotary switched shower of claim 1, wherein an assembly hole is set up at the top of the shell, and at the end of the said handle a head is added down-facing, which is inserted into the assembly hole and is fixed to the turntable with a screw.

8. The rotary switched shower of claim 1, wherein A switching method of the rotary switched shower, comprises the following steps: (1) turn the shell to rotate relative to the handle, when the water inlet hole in the turntable fixed to the handle connects with the one of the function water holes, the relevant function water channel is connected. (2) to continue to turn the shell to rotate relative to the handle, when the water inlet hole in the turntable fixed to the handle connects with another one of the function water holes, the relevant function water channel is connected.
